(19) United States
(12) Patent Application Publication
(10) Pub. No.: US 2014/0220381 A1
(43) Pub. Date: Aug. 7, 2014

(54) CLAD SHEET FOR MOTOR VEHICLE BODY

(71) Applicants: Estelle Muller, Grenoble (FR); Sylvain Henrry, Saint Jean de Moirans (FR); Gilles Guiglionda, Seyssinet-Pariset (FR)

(72) Inventors: Estelle Muller, Grenoble (FR); Sylvain Henrry, Saint Jean de Moirans (FR); Gilles Guiglionda, Seyssinet-Pariset (FR)

(73) Assignee: CONSTELLIUM FRANCE, Paris (FR)

(21) Appl. No.: 14/241,300

(22) PCT Filed: Aug. 30, 2012
(86) PCT No.: PCT/FR2012/000344

§ 371 Date: Feb. 26, 2014

(30) Foreign Application Priority Data
Sep. 2, 2011 (FR) 11/02673

(51) Int. Cl. B32B 15/01; B23K 20/02

(52) U.S. Cl. CPC B32B 15/016; B23K 20/02
USPC 428/654; 228/117

(57) ABSTRACT

The subject of the invention is a composite sheet material made of aluminium alloy for motor vehicle body components, in which a cladding sheet is applied to at least one side of a core, the compositions of the core and of the cladding sheet, in weight percentages, being such as below (See table): other elements <0.05 each and 0.15 in total, remainder aluminium. Another subject of the invention is the process for manufacturing said composite sheet material by co-rolling.

### SCOPE OF THE INVENTION

The invention concerns the field of Al—Si—Mg alloy sheets, in particular made of AA6xxx series alloys as per the designation of the “Aluminum Association”, intended for the manufacture, especially by drawing and/or hemming, of motor vehicle body components, such as wings, doors, boots, hoods, roofs or other parts of the body structure.

More specifically, the invention relates to a composite material for motor vehicle body components, consisting of aluminum alloy sheets, wherein a clad sheet is applied to at least one side of a core sheet, both having an optimized composition for using the clad material for motor vehicle body components.

The invention also relates to the manufacturing method for said composite material sheet by co-rolling.

### STATE OF THE ART

Aluminum is increasingly used in the automotive industry to reduce vehicle weight and reduce fuel consumption and emissions of pollutants and greenhouse gases.

The sheets are mainly used for the manufacture of bodywork skin parts, especially closures, including doors, hoods and boots, but also roofs and structural components of the body also called “Body in white (BIW)”.

This type of application requires a set of sometimes conflicting properties, such as:
high formability for such drawing and/or hemming operations,
high strength after paint baking to obtain good general resistance and dent resistance while minimizing the weight of the part,
a yield strength well mastered at delivery condition of the sheet to control springback when shaping,
stability of formability properties and in particular hemming ability of the material at delivery condition during extended waiting before shaping,
good ability to absorb energy upon impact for application to body structure parts,
good surface quality after shaping and painting, especially no Luders lines and no or minimal presence of what is known to experts in the field as roping or aligned roughness created during shaping,
good behavior in various assembly processes used in motor vehicle body components such as spot welding, laser welding, FSW welding, gluing, clinching or riveting,
good corrosion resistance, in particular filiform corrosion of painted parts,
compatibility with the requirements of recycling manufacturing waste or recycled vehicles,
an acceptable cost for mass production.

All aluminum alloys discussed in the following are designated, unless otherwise stated, according to the designations defined by the “Aluminum Association” in the “Registration Record Series” that it publishes regularly.

The requirements mentioned above have led to the choice of Al—Mg—Si alloys, i.e. alloys of the AA6xxx series.

In Europe, AA6016 and AA6016A alloys, with thicknesses of the order of 1 to 2.5 mm, are most commonly used for this application, because they lead to a better compromise between the required properties, in particular by ensuring better hemming ability and better resistance to filiform corrosion, than alloys with a higher copper content such as alloy AA6111 widely used in the United States.

AA6016 type alloys are described in particular in patents FR 2,360,684 by “Alusuisse” and EP 0259232 by “Cegedur Pechiney”, while alloys of the AA6111 type are described in U.S. Pat. No. 4,614,552 by “Alcan International Ltd”.

However, the mechanical strength of alloy AA6016 after paint baking remains significantly lower than that of AA6111, and even more so as the baking temperature tends to decrease, so that hardening by aging is less effective.

For this reason, and to provide more substantial lightweighting, motor vehicle manufacturers are seeking higher mechanical resistance after painting.

For this purpose, the company “Pechiney” developed new variants of the AA6016 alloy, in particular a variant “DR120” giving a yield strength after quenching, tensile 2% stretching, and paint baking, typically for 20 min. at 185° C., in the order of 240 MPa. These developments were described in publications, particularly in articles by R. Shahani et al. “Optimised 6xxx aluminum alloy sheet for autobody outer panels” Automotive Alloys 1999, Proceedings of the TMS Annual Meeting Symposium, 2000, pp. 193-203, and by D. Daniel et al. “Development of 6xxx Alloy Aluminum Sheet for Autobody Outer Panels: Bake Hardening, Formability and Trimming Performance” IBEC'99—International Body Engineering Conference, Detroit, 1999, SAE Technical Paper N ° 1999-01-3195.

Meanwhile, Alcan proposed a new variant of alloy AA6111, called 6111-T4P, giving an improved yield strength after paint baking, (typically 270 to 280 MPa) without reduction in formability in the T4 temper. This product has been described in particular in the article by A. K Gupta et al. “The Properties and Characteristics of Two New Aluminum Automotive Closure Panel Materials”, SAE Technical Paper 960164, 1996.

Finally, “Pechiney” in its application EP1633900 proposed an especially hard alloy for car roofs of AA6056 type, the shaping of which must therefore be performed in the T4 temper, but hemming ability obviously remains limited.

These new developments mostly include optimized heat treatment of the pre-aging type, performed after quenching to improve hardening from paint baking. In the absence of such treatment, the hardening kinetics on baking decreases with the waiting time at room temperature between quenching and baking, and a wait of several weeks is practically inevitable in industrial production. This phenomenon has long been known and was described for example in the article by M. Renouard and R. Meillat: “Le pre-revenu des alliages aluminium-magnesium-silicium”, Mémoires Scientifiques de la Revue de Metallurgie, December 1960, pp. 930-942. Pre-aging treatment is the subject of patent EP 0949344 by “Alcan International Ltd”.

Considering the growing development of the use of aluminum alloy sheets for motor vehicle body components and large-scale production runs, there is always a demand for ever improved grades to reduce thicknesses without impairing the other properties so as to always increase lightweighting.

Obviously, this development involves the use of alloys of increasingly high yield strengths, and the solution described above, of using the ever more resistant alloys of the AA6xxx series, shaped in the T4 state, i.e. after solution heat-treatment and quenching, hardening greatly during the operations of pre-aging and baking of paints and varnishes, is reaching its limits. It gives increasingly hard alloys as of the T4 temper, and therefore poses serious problems of shaping, especially during severe operations such as hemming an exterior panel onto an inner panel or deep drawing.

To solve these problems, workarounds involving changing the geometry of the parts or “downgrading” the shaping process and therefore the shape characteristics of the part so obtained were first used to accommodate these unformable alloys.

For example, a so-called “rope hem” A method of hemming may be used instead of the usual “flat” B method, for such alloys with poor hemming ability, but with the negative effect of increasing the apparent gap 1 between the hemmed edge and other parts of the body for the same real gap 2 as shown in FIG. 1.

In the case of an alloy of low drawing ability, we may make changes to shapes or reduce retention efforts, using beads and very large tooling radii. In this way, one can certainly stamp the part more easily, but it is then particularly difficult to control its geometry, and the range of possible shapes is reduced.

In either case, these solutions require significant concessions on part geometry to be made and the need to improve the formability of sheets with high mechanical characteristics remains particularly acute.

Other solutions, focusing more on the material itself, have also emerged to improve the usual compromise of material properties such as the balance between high strength and good formability. In cases where one single material would not improve this compromise, the use of a composite material consisting of a sandwich of co-laminated sheet has made it possible, by combining the different properties of the sheets making up the composite, to obtain simultaneously improvement of two or more properties usually considered as antagonists.

Composite materials made up of co-laminated sheets are well known in the field of brazing sheets for heat exchangers generally combining a core made of the aluminum alloy series AA3xxx and a clad sheet or skin of the AA4xxx alloy series.

Certain aeronautical applications also use sheets with an aluminum alloy core of the AA2xxx series in conjunction with clad sheets made of 1xxx series alloy. In both these cases of applications, the need is to meet specific requirements for brazability, related to heat transfer, corrosion or erosion-corrosion and mechanical resistance, but with no point in common with the problem solved by the present invention.

Applications are also known in the field of motor vehicle body components.

Some are designed to use a core imparting mechanical properties in conjunction with a clad sheet giving a good appearance or corrosion resistance or a good resistance to scratching or scuffing during shaping. Applications JP 551 13856 and JP 551 13857 by “Sumitomo” combine cores made from series AA7xxx and AA2xxx respectively with clad made from AA5xxx series alloys to manufacture bumpers combining high mechanical properties, good corrosion resistance and brightness.

Applications JP 5318147 and JP 5339669 by “Sky Aluminum” combine a core made from alloy series 5xxx alloy and a clad sheet made from 4xxx or 6xxx series alloys for surface precipitation hardening to improve resistance to scratching or scuffing during shaping.

In the same spirit, and to give the surface improved resistance to corrosion, application FR 2877877 by “Corus Aluminium” describes the combination of core alloys of the 5xxx or 6xxx series with clad alloys of 1xxx, 3xxx or 7xxx series with a low zinc content.

Finally, applications JP 62158032 and JP 62158033 by “Kobe Steel” are for motor vehicle body plated sheets with good bendability consisting of a core sheet made of a AA5xxx series alloy and a clad alloy containing 99% or more of aluminum. But this solution has the drawback of limited resistance, from a general point of view due to the use of the 5xxx series alloys, and moreover, without hardening during paint baking, but still more so in terms of dent resistance due to the use of a particularly “soft” clad alloy.

Still for use in the field of motor vehicle body components, other composite materials consisting of co-rolled sheets combine 6xxx alloys with each other. Application WO 2009/059826 A1 by “Novelis Inc.” discloses, for this purpose, a composite material made of aluminum alloy sheet, wherein a cladding sheet or clad is applied on at least one side of a core sheet, the compositions of which, as percentages by weight, are as follows:

| | Si | Fe | Cu | Mn | Mg | Cr | Zn | Ti |
|---|---|---|---|---|---|---|---|---|
| Core | 0.9-1.4 | <0.3 | 0.75-1.4 | <0.4 | 0.9-1.4 | <0.2 | <0.05 | <0.05 |
| Clad | 0.3-0.8 | <0.3 | <0.3 | <0.3 | 0.3-0.7 | <0.05 | <0.05 | <0.05 |

other elements <0.05 each and 0.15 in total, the remainder being aluminum.

The high content of magnesium, silicon and copper in the core alloy and the high levels of magnesium and silicon in the alloy constituting the clad sheet give the clad sheet a very high mechanical resistance after shaping and paint baking. The corrosion resistance of the core alloy, which has a high copper content, is improved on the surface by the clad. But the hemming ability of the composite material, although better than that of a sheet made from AA6111 alloy, remains limited particularly after pre-deformation. Hemming ability stability over time, drawing performance and surface quality after shaping, in particular the presence of roping, are not addressed.

Application EP 2 052 85 1 A 1 by “Aleris Aluminum Duffel BVBA” describes, again for this use, a composite material of aluminum alloy sheets, the compositions of which, as percentages by weight, are as follows:

| | Si | Fe | Cu | Mn | Mg | Cr | Zn | Ti |
|---|---|---|---|---|---|---|---|---|
| Core | 1.0 | 0.23 | 0.15 | 0.07 | 0.6 | 0.03 | <0.05 | 0.02 |
| Clad | 0.4-0.9 | <0.3 | <0.25 | <0.5 | 0.4-0.8 | <0.3 | <0.3 | ≦0.35 |

other elements <0.05 each and 0.15 in total, the remainder being aluminum.

The claims stress that the clad must have a copper content of less than 0.25% or preferably less than 0.20%, and preferably belong to the AA6005 or AA6005A series, while the core alloy may contain up to 1.1% copper. Again, the subject of the invention appears to be to improve the corrosion resistance and hemming ability of high strength core alloys with a high copper content. Hemming ability stability over time, drawing ability and surface quality after shaping, in particular the presence of roping, are not addressed.

Finally, application EP 2 156 945 A1 by “Novelis Inc.” describes, again for this use, a composite material of aluminum alloy layers, the compositions of which, as percentages by weight, are as follows:

| | Si | Fe | Cu | Mn | Mg | Cr | Zn | Ti |
|---|---|---|---|---|---|---|---|---|
| Core | 0.45-0.7 | ≦0.35 | 0.05-0.25 | 0.05-0.2 | 0.45-0.8 | <0.05 | <0.05 | <0.05 |
| Clad | 0.3-0.7 | ≦0.35 | <0.05 | ≦0.15 | 0.3-0.7 | <0.05 | <0.05 | <0.05 |

other elements <0.05 each and 0.15 in total, the remainder being aluminum.

This latter reference shows, in FIGS. 1-4, a net change of bendability with natural aging time, which can cause problems in industrial conditions under which said time is often variable. While the material of the invention seems to have solved this problem, its strength after shaping and paint baking is limited. Drawing ability and surface quality after shaping, in particular the presence of roping, are not addressed.

As explained, drawing performance and the phenomenon of roping, well known to experts in the field and resulting in aligned roughness created during shaping, are not covered by any of the above references. No state of the art materials can provide the optimal compromise sought here for a motor vehicle body in white application, between good formability for drawing and hemming at delivery condition, stability of these formability properties and especially bendability according to natural aging time, sufficiently high mechanical strength after forming and paint baking, corrosion resistance on the surface and in the core, and good surface appearance after the part has been shaped or shaped and painted.

In contrast, the material according to the invention, by combining a particularly draw able and sufficiently strong core alloy with a more able to hemming clad alloy having an excellent surface appearance after shaping, but both belonging to the 6xxx family of alloys, and therefore capable of hardening during paint baking, makes it possible to combine an aptitude for shaping, in particular drawing and hemming in the T4 temper or T4P pre-aging temper with final levels of mechanical properties after paint baking, quality of appearance and corrosion resistance that are thoroughly advantageous.

### The Problem

The invention aims to obtain an optimal balance of properties often considered as antagonists, proposing as it does a composite material made of aluminum alloys for motor vehicle body components with optimized composition, ensuring sufficient formability, stable over time and better than state of the art, for deep drawing and hemming in severe conditions, sufficient dent resistance by marked hardening during paint baking, while controlling the quality of appearance, springback, good behavior during assembly according to the various processes used in motor vehicle bodywork, cutting without flaking, and good corrosion resistance particularly to filiform and intergranular corrosion and ease of recycling. It is also aims to minimize the phenomenon of roping created during shaping.

### Subject of the Invention

The invention relates to a composite material of aluminum alloy sheets for automobile body components, wherein a clad sheet, or clad, is applied on at least one side of a core, the compositions, as a percentage by weight, being as given below:

| | Si | Fe | Cu | Mn | Mg | Cr | Zn | Ti |
|---|---|---|---|---|---|---|---|---|
| Core | 0.75-1.3 | <0.3 | <0.3 | 0.05-0.3 | 0.4-0.8 | <0.2 | <0.3 | <0.2 |
| Clad | 0.3-0.9 | <0.3 | <0.3 | 0.05-0.3 | 0.15-0.30 | <0.2 | <0.3 | <0.2 |

other elements <0.05 each and <0.15 in total, the rest aluminum

Advantageously, the silicon content of the core is between 1.1 and 1.3.

With regard to the magnesium content of the core, this is advantageously between 0.4 and 0.7, just as the manganese content of the core is advantageously between 0.05 and 0.2, while the copper content of the core may be limited to 0.2 for applications in severe corrosive conditions.

Regarding the silicon content of the clad, this is preferably between 0.45 and 0.65, just as the magnesium content of the clad is advantageously between 0.23 and 0.29 while the manganese content of the clad is advantageously between 0.10 and 0.30.

Generally, the clad is applied to the core by co-rolling.

According to a particular embodiment, a clad is applied on one side of the core only. According to another embodiment, a clad is applied on both sides of the core.

According to a variant of the invention, the thickness of the, or of each clad, is 5% of the total thickness of the composite material and, in another embodiment, it is 10% of the total thickness of the composite material.

Typically, the composite sheet material of the invention has a “three-point bending angle” a measured according to NF EN ISO 7438, in the T4P temper after pre-stretching by 10% (α_{10%}), or solution heat-treated, quenched, pre-aged by winding, typically between 50 and 85° C., and slowly cooled in the coil to room temperature, by at least 140° after pre-stretching by 10%.

In addition, this “three point bending angle” α_{10%}% obtained just after pre-stretching of 10%, by at least 140°, is substantially invariant with the waiting time at room temperature after cooling of the coil, or typically a change of less than 5°, for a waiting time of up to at least 6 months.

Another typical characteristic of the material according to the present invention is that it has a yield strength Rp0,2, after solution heat-treatment, quenching, pre-aging by winding, typically between 50 and 85° C., and slow cooling in a coil down to room temperature, tensile pre-strain of 2% and paint baking treatment for 20 min. at 185° C., of at least 200 MPa or 220 MPa which represents hardening when shaping and paint baking of at least 80 MPa.

Advantageously, the composite sheet material according to the invention is used to make a motor vehicle body sheet.

According to various embodiments, the body sheet of the invention is a drawn sheet or a hemmed sheet or a drawn and hemmed sheet.

Finally, the invention also encompasses a method of manufacturing the composite aluminum alloy sheet material for motor vehicle body components according to one of the aforementioned embodiments, wherein a cladsheet is applied by co-rolling on at least one side of a core, the compositions of the core and the clad sheet being, as percentages by weight, as follows:

| | Si | Fe | Cu | Mn | Mg | Cr | Zn | Ti |
|---|---|---|---|---|---|---|---|---|
| Core | 0.75-1.3 | <0.3 | <0.3 | 0.05-0.3 | 0.4-0.8 | <0.2 | <0.3 | <0.2 |
| Clad | 0.3-0.9 | <0.3 | <0.3 | 0.05-0.3 | 0.15-0.30 | <0.2 | <0.3 | <0.2 |

other elements <0.05 each and 0.15 in total, the remainder being aluminum.

### DESCRIPTION OF THE FIGURES

FIG. 1 shows the visible or apparent gaps 1 for the same real gap 2 between the hemmed edge and the other parts of the body during a “rop hem hemming” A and during conventional “flat” hemming B

FIG. 2 shows the device for the “three-point bending test” consisting of two rollers R and a punch B with radius r to bend the sheet T of thickness t.

FIG. 3 shows sheet T after the “three-point bending” test with the internal angle β and the external angle, measured test result: α.

FIG. 4 shows the results of the “three-point bending” test performed on 1 mm plates in T4P temper after pre-stretching by 10%, or solution heat-treated, quenched, and pre-aged by winding, typically between 50 and 85° C., slowly cooled, and then pre-stretched by 10% just prior to the “three-point bending test”, or, on the Y-axis, the external angle α_{10%} in degrees for core sheet Ai, clad sheet Pi, and composite Ci, for reference materials A3, P3 and C3, and materials according to the invention: A1, P1, C1 and A2, P2, C2.

FIG. 5 shows the variation of said angle α_{10%}, in degrees, measured in T4P temper after pre-stretching by 10%, for the core sheet A1, the clad sheet P1 and the composite material of the invention C1 obtained from said plates, as a function of time t, in days waiting (or natural aging) at room temperature after cooling the coil.

FIG. 6 shows, on the Y-axis, the angle in degrees, measured in the T4P temper after pre-stretching by 10%, and, on the X-axis, the yield strength Rp_{0,2}-BH in MPa, measured after solution heat treatment, quenching, pre-aging, pre-stretching by 2% and paint baking treatment for 20 min. at 185° C. for various monolithic sheets reference A1, A3, P1, P2, P3, M1, M2, M3, M4, and for the two sheets of composite materials according to the invention, C1 and C2.

FIG. 7 shows, on the Y-axis, the angle α_{10%} in degrees, in the T4P temper after pre-stretching by 10%, and, on the X-axis, the yield strength Rp_{0,2}-BH in MPa, for the composite materials according to the invention C1 and C2, for the composite material outside the invention C3, and for their constituents A1, A3, P1, P2, P3.

FIG. 8 specifies the dimensions in mm of the tools used to determine the value of the parameter known to experts in the field as LDH (Limit Dome Height) characteristic of the drawing ability of the material.

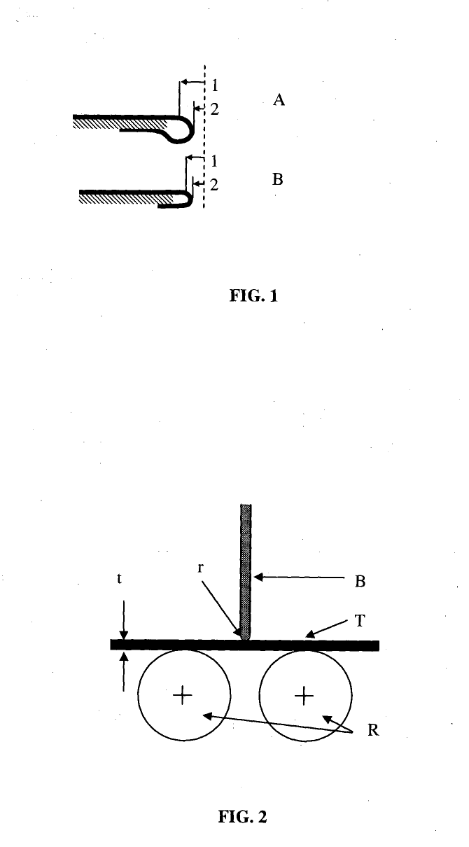

### DESCRIPTION OF THE INVENTION

The invention is based on the use of a composite material sheet wherein a clad shet is applied on at least one side of a core, both made of aluminum alloy of the same series and of specific composition, and on the unexpected finding made by the applicant that the combination of a core alloy that is “hard” but formable only with difficulty, and a skin alloy of the clad sheet, or “clad”, that is formable but insufficiently strong, provides, despite relatively small clad thicknesses, a very formable material, in particular in the T4 temper, i.e. after quenching, and with high mechanical properties, especially after paint baking treatment possibly in conjunction with pre-aging treatment as mentioned above.

The above mentioned specific compositions are as given below, as percentages by weight:

| | Si | Fe | Cu | Mn | Mg | Cr | Zn | Ti |
|---|---|---|---|---|---|---|---|---|
| Core | 0.75-1.3 | <0.3 | <0.3 | 0.05-0.3 | 0.4-0.8 | <0.2 | <0.3 | <0.2 |
| Clad | 0.3-0.9 | <0.3 | <0.3 | 0.05-0.3 | 0.15-0.30 | <0.2 | <0.3 | <0.2 |

other elements <0.05 each and <0.15 in total, the rest aluminum.

The concentration ranges imposed on the components of each alloy are explained by the following reasons:

Si improves the mechanical properties by precipitating with Mg as Mg₂Si during paint baking. An excess of silicon with respect to the stoichiometry of Mg₂Si is favorable for good formability when stamping and substantial hardening during paint baking. In contrast, too high a level is detrimental to formability when hemming.

Because of this, the range is made up of higher values for the core alloy than for the clad alloy.

Mg, as of 0.15%, associated as seen above with Si, and depending on any pre-aging conditions, makes hardening possible during paint baking. The concentration range therefore logically includes values of 0.4 to 0.8% higher for the core alloy, for which considerable strength is sought, compared to 0.15 to 0.30% (with an optimum of 0.23 to 0.29) for the clad alloy for which formability is sought, in particular by bending. A minimum of 0.15% in the clad, combined with relatively high Si contents, is sufficient to obtain a proper dent resistance.

The magnesium content in the clad is deliberately limited to 0.3% so as to obtain excellent bendability irrespective of the waiting time between the end of processing the material and shaping by bending or hemming.

Mn improves bendability due to the fact that it forms with Si dispersoids of the Al—Mn—Si type, because of its action on the formation of a iron eutectic phases during casting and homogenization, more favorable for formability than the “beta” phase, and because of its action on controlling final grain size. It also limits quench sensitivity by avoiding too high a concentration of precipitates at the grain boundaries.

At high concentrations, the risk of formation of coarse primary intermetallic compounds is a significant one, with a noticeable reduction in ductility and formability.

Fe, which is generally an impurity for aluminum, is only slightly soluble in aluminum and is therefore found in the form of second phase particles, such as FeAl₃ or Al(Fe,Mn)Si, often preferably present at grain boundaries and unfavorable to formability and in particular for bending. Because of this, its content is limited to 0.3% in the clad alloy and in the core alloy, although this latter effect is less restrictive according to the very principle of the invention, due to the presence of the very able to hemming clad sheet.

Cu contributes to the hardening of the alloy during paint baking. However, its negative effect on resistance to corrosion, essentially filiform, leads one to limit its content to 0.3% in the core alloy and in the clad alloy forming the skin of the composite material and therefore directly exposed to such corrosion. For some critical applications, and depending on the methods and types of coating, in particular for application to outer panels, especially hemmed ones, this limit can be reduced to 0.2%.

Furthermore, the core alloy may be in more or less direct contact with the outside, especially via drilled or cut edges or after significant sanding of the skin to correct surface defects or during repairs. Assembly operations, including welding, may also bring parts of the core up to the surface. To accommodate these situations, the Cu content of the core is also limited to 0.3%.

Zn somewhat improves mechanical properties, but for values up to 0.3%, it especially has a positive effect on the resistance to structural intergranular corrosion. Therefore, adding it in this proportion to the core alloy, especially containing copper, may be advantageous. Beyond this limit, its negative effect on formability and the risk of excessively reducing corrosion potential mean that it is of no interest.

Finally, Ti and Cr are used to control the grain size and, for application to the cladding sheets, to prevent the appearance of an orange peel effect during severe deformations such as hemming or deep drawing. Their content is limited to 0.2% of each because, on the contrary, they adversely affect formability at higher concentrations.

The composite material may comprise a single sheet of clad. In this case, for application to a hemmed panel, the sheet or clad sheet is placed so that during the hemming operation, it is on the outside. It may also contain a clad sheet on each side of the core alloy sheet.

The thickness of the clad sheet or of each clad sheet is 5 to 10% of the total thickness of the composite material. Even at low cladding thicknesses, typically 3%, a very significant improvement in formability including bending and stamping, is observed while the mechanical properties, especially yield strength Rp_{0,2}, are only slightly affected.

Beyond 20% of the total thickness in the case of two clad sheets each of thickness greater than 10%, the loss in mechanical properties becomes too large for the invention to be of any interest as compared to a monolithic sheet.

Specifically, the thickness of the clad sheet, or of each clad sheet is chosen as 5% to encourage a minimum drop in strength or as 10% to retain satisfactory formability or energy absorption capacity in the event of an impact.

Note also that the clad sheet used for the composite material according to the invention gives an excellent surface quality, with in particular little or no roping, the word used by experts in the field to describe the aligned roughness created during shaping, and it also hides any possibly less efficient behavior of the core.

Finally, the present invention also relates to the manufacture of such composite sheet materials wherein a clad sheet of metal alloy of the above composition is applied to at least one side of a core sheet made of an alloy whose composition has also been given above.

Beforehand, this includes preparing, casting and possibly rolling, of a core alloy plate and a plate, or two plates in the case of cladding on both sides of the core, with thickness(es) different from that of the core.

These sheets correspond to the two or three sheets of the composite product to be made. They are then superposed and the assembly is hot rolled and, if the final thickness to be obtained requires it, cold rolled.

Rolling is performed in a number of passes with, if necessary, one or more intermediate annealing operations between certain passes.

Of course, the use of this method, which is the most common one, is not exclusive; the material according to the invention can be obtained by a process of semi-continuous vertical casting of plates comprising at least two aluminum alloys (core and cladding(s)), or by simultaneous casting, typically by means of at least one separator, such as in particular, but not exclusively, the method described in French patent application Ser. No. 11/02197 of Jul. 12, 2011 by the applicant.

The details of the invention will be understood better with the help of the examples below, which are not, however, restrictive in their scope.

### EXAMPLES

### Preamble

### Hemming Ability Test

The ability to hemming of the various materials tested is measured by a “three-point bending test” according to standard NF EN ISO 7438.

The bending device is as shown in FIG. 2.

Firstly, a 10% tensile pre-strain is performed on sheet T in the direction of rolling, and then the “three-point bending” itself is carried out using a punch B with radius r=0.2 mm, the sheet being supported by two rollers R, the bending axis being perpendicular to the rolling and pre-stretching direction. The rollers have a diameter of 30 mm and the distance between the roller axes is 30+2t mm., t being the thickness of the plate T being tested.

At the beginning of the test the punch is brought into contact with the sheet with a strain of 30 Newtons. Once contact is established, the movement of the punch is indexed to zero. The test then involves moving the punch so as to perform the “three-point bending” of the sheet.

The test stops when micro-cracking of the sheet leads to a drop in force of the punch by at least 30 Newtons, or, if there is no micro-cracking, when the punch has moved 14.2 mm, which corresponds to the maximum permissible travel.

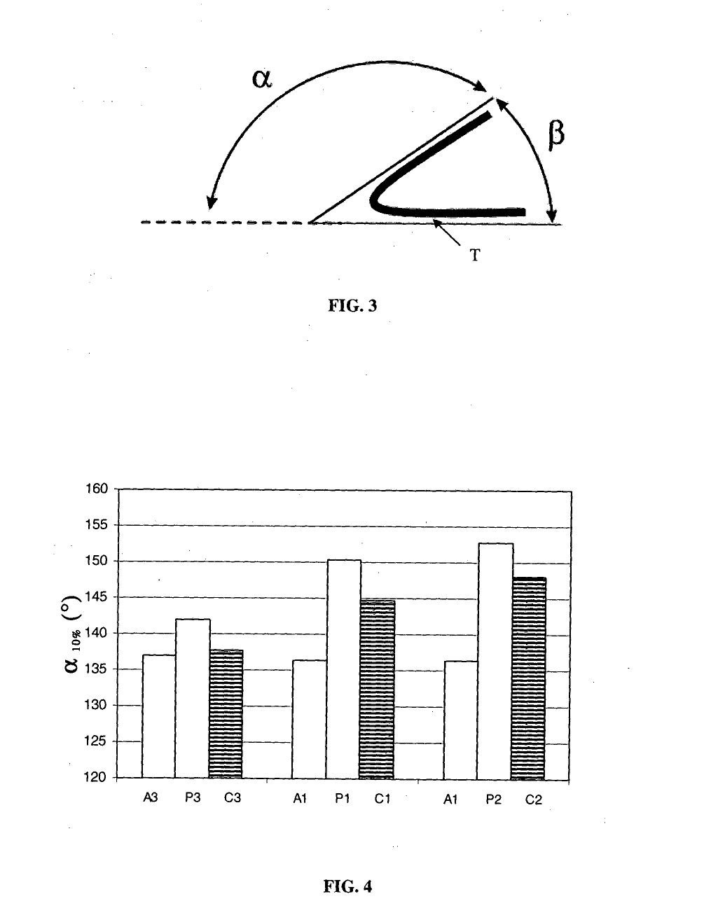

At the end of the test, the sample sheet is bent as shown in FIG. 3. Hemming ability is then evaluated by measuring the bending angle in degrees. The greater the angle, the higher the hemming ability or bendability of the sheet.

### Example 1

The composite sheet materials used in this example were produced by hot co-rolling, a method well known to experts in the field and as used for the production of brazing sheets.

From a core sheet A and two finer clad sheets P a composite material C with a final total thickness of 1 mm was produced three times by hot co-rolling, hot rolling and cold rolling; the composite material had therefore on each side two clad sheets each of which accounted for 5% of the total thickness of 1 mm, or 50 microns.

The composite material C1 according to the invention is composed of a core sheet of composition A1 and two clad sheets of the same composition P1.

The composite material C2 according to the invention is composed of a core sheet of composition A1 and two clad sheets of the same composition P2.

By way of comparison, a third composite material C3 was also made from a core sheet of composition A3 and two clad sheets of the same composition P3.

The compositions of the three sheets making up the composite materials, expressed in percentages by weight, are summarized in Table 1 below:

TABLE 1

| | Si | Fe | Cu | Mn | Mg | Cr |
|---|---|---|---|---|---|---|
| A1 | 1.24 | 0.19 | 0.22 | 0.07 | 0.40 | 0.01 |
| P1 | 0.52 | 0.24 | 0.09 | 0.17 | 0.25 | 0.01 |
| P2 | 0.56 | 0.24 | 0.09 | 0.30 | 0.25 | 0.01 |
| A3 | 1.19 | 0.20 | 0.22 | 0.08 | 0.32 | 0.01 |
| P3 | 0.60 | 0.13 | 0.09 | 0.18 | 0.66 | 0.03 |

other elements <0.05 each and 0.15 in total, the remainder being aluminum.

After cold rolling, the three sheets of composite materials were solution heat treated at 530° C., quenched and pre-aged by winding at about 85° C. with slow cooling in the coil at room temperature.

In parallel, five plates corresponding to each of the compositions in Table 1 were processed in a standard way so as to obtain sheets with a thickness of 1 mm after hot rolling, of each of the constituents of the composite materials. The rest of the transformation procedure was identical for the three composite sheets, C1, C2, C3 and for the five monolithic sheets A1, P1, P2, A3, P3.

After a two-week wait at room temperature, hemming ability of the different materials, then in the T4P temper, was evaluated according to the procedure described in the preamble.

Note that the 10% tensile pre-strain is used to simulate hemming behavior in areas that have been previously greatly deformed during actual shaping by stamping. It also makes the three point bending test more severe so that the majority of standard materials used in the form of sheets for motor vehicle body components (AA6111, AA6016, AA6014, AA6005A) begin to crack before the punch reaches its maximum travel of 14.2 mm.

The results of these tests are shown in FIG. 4. It can be seen that the bending angles after 10% tensile pre-strain of both materials A1 and A3 constituting the cores of the composites, are similar, even though A3 bends slightly better than A1.

In contrast, the three materials P1, P2 and P3, constituting the clad of the composites, have significantly different behavior: P1 and P2, in accordance with the invention, have bending angles α_{10%}greater than 140° while P3, non-compliant, is the least bendable material of the three. Overall, when comparing the three materials, P2 is the most bendable material and P3 the least.

It is interesting to note that the bending performance of the composite materials is similar to that of their respective covers, even though the proportion of clad on the outer face of the bended sample is only 5% of the total thickness of the composite material. So C2 is the most pliable material and C3 the least.

Composite materials C1 and C2 according to the invention have a bending angle after 10% tensile pre-strain greater than 140° in contrast to material C3 outside the scope of the invention.

### Example 2

The same three materials A1, P1 and C1 from Example 1 were used.

We investigated here the influence of waiting time at room temperature between the end of processing of the coil such as in Example 1 and performance of the bending test, or natural aging time. In industrial processes, there is often a waiting period between the sheet being delivered and being used for the manufacture of a body part; this period is variable but may be up to 6 months.

After waiting at room temperature for a variable amount of time, sheets A1, P1 and C1 underwent the “three-point bending test” as described above.

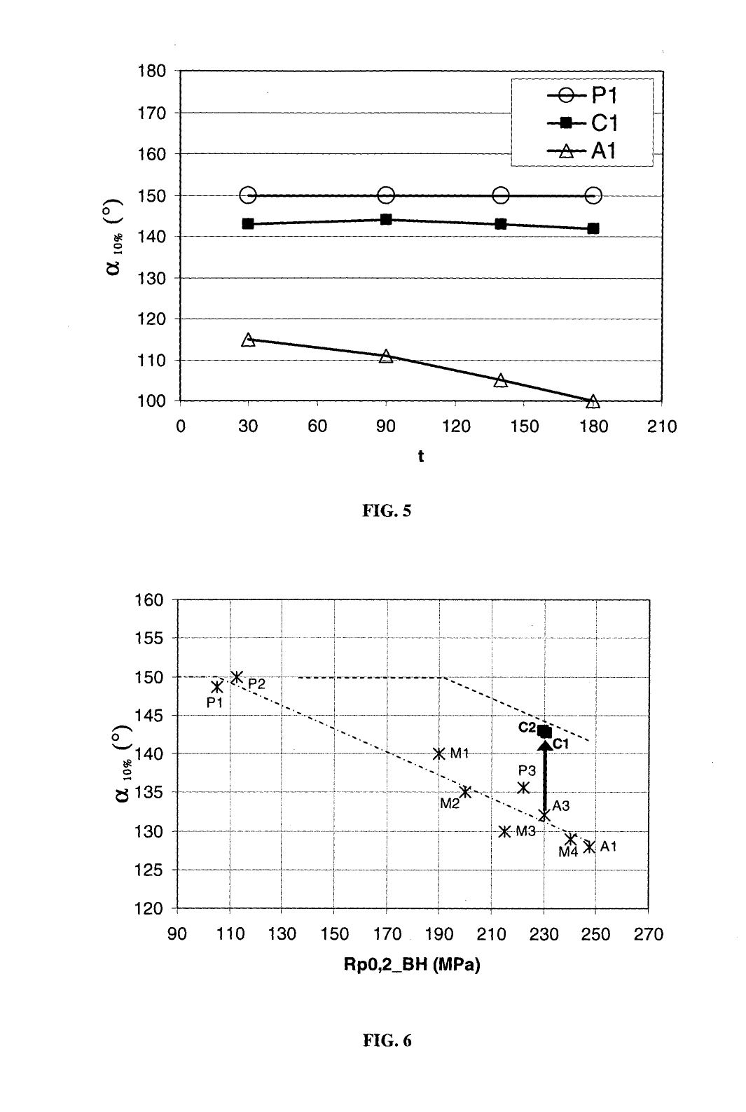

The results are shown in FIG. 5 with, on the Y-axis, the bending angle values in degrees and on the X-axis, said waiting time in days.

It can be seen that the bendability of material P1 constituting the clad of composite C1 is excellent since angle α of 150° is obtained for a punch travel of 14.2 mm, which is the maximum punch travel allowed in this test. It can also be noted that this value is obtained and is stable whatever the waiting or natural aging time.

Material A1 constituting the core of the composite has poorer bendability with angle α values significantly less than 140°. Moreover, it is found that waiting is clearly detrimental to this material, leading to a value for angle α of only 100° after 6 months. Composite material C1 according to the invention, consisting of a core of composition A1 clad with two layers of 50 microns of composition P1, has very good bendability with angle α values greater than 140°. It is very interesting to note that the bendability of this composite C1 according to the invention does not deteriorate over time when waiting time is extended. Here too the bendability of the clad seems to control the first order bendability of the composite.

Making composite material C1 according to the invention thus vividly improves bendability performance of the monolithic A1 core material, firstly by increasing the value of the angle α to almost that of its cladding P1, and secondly by making the bendability of the composite C1 insensitive to waiting between the end of processing of the coil and bending up to a period of six months later, or a change of typically less than 5°.

### Example 3

In this example, the two composite materials of Example 1, C1 and C2, according to the invention, were used.

By way of comparison, several monolithic sheets 6xxx alloys were manufactured using the same method (semi-continuous vertical casting, homogenization, hot rolling, cold rolling, solution hardening, quenching and pre-aging).

The compositions of the monolithic sheets expressed as percentages by weight are summarized in Table 2 below.

TABLE 2

| | Si | Fe | Cu | Mn | Mg | Cr |
|---|---|---|---|---|---|---|
| A1 | 1.24 | 0.19 | 0.22 | 0.07 | 0.40 | 0.01 |
| P1 | 0.52 | 0.24 | 0.09 | 0.17 | 0.25 | 0.01 |
| P2 | 0.56 | 0.24 | 0.09 | 0.30 | 0.25 | 0.01 |
| A3 | 1.19 | 0.20 | 0.22 | 0.08 | 0.32 | 0.01 |
| P3 | 0.60 | 0.13 | 0.09 | 0.18 | 0.66 | 0.03 |
| M1 | 0.57 | 0.24 | 0.08 | 0.13 | 0.53 | 0.03 |
| M2 | 1.09 | 0.26 | 0.09 | 0.18 | 0.38 | 0.04 |
| M3 | 1.05 | 0.26 | 0.09 | 0.16 | 0.37 | 0.03 |
| M4 | 1.05 | 0.25 | 0.08 | 0.15 | 0.42 | 0.03 |

other elements <0.05 each and 0.15 in total, the remainder being aluminum.

Firstly, the conventional yield strength Rp_{0,2} according to standard NF EN 10002-1 was measured after 2% tensile pre-strain and heat treatment for 20 minutes at 185° C. simulating shaping and paint baking during the manufacture of motor vehicle body parts (called Rp_{0,2}-BH).

Secondly, after a 45 days wait at room temperature, hemming ability of the different materials, then in the T4P temper, was evaluated according to the same procedure as described above.

These two features, namely hemming ability in T4P temper with a wait of 45 days and 10% tensile pre-strain, and Rp_{0,2}-BH after 2% tensile pre-strain and 20 min. at 185° C., are fairly representative of the expected performance for a sheet designed for the manufacture of body parts.

Indeed, the sheet must first be hem able after shaping in T4P state and should also give a high yield strength in service, i.e. that of motor vehicle parts mounted on the assembled vehicle, after shaping and paint baking.

The results are shown in FIG. 6 with, on the Y-axis, the bending angle in degrees and on the X-axis, Rp_{0,2}-BH in MPa.

It shows that the points corresponding to monolithic plates are aligned on a straight line. Alloys with the best hemming ability have low Rp_{0,2}-BH values. Conversely, alloys that give the highest Rp_{0,2}-BH values are less hem able in the T4P state.

The line on which the monolithic alloys are aligned represents the achievable compromise between these two properties, for monolithic sheets.

It can be seen, however, that points C1 and C2, corresponding to composite plates according to the invention have significantly higher hemming ability, with a bending angle of 143°, for an Rp_{0,2}-BH value that is also high, in the order of 230 MPa, a much more interesting compromise.

### Example 4

In this example, the composite materials from Example 1 were used again.

The same characterizations as described in Example 3 were made, namely measuring the value of Rp_{0,2}-BH and “three point bending” test using the same method.

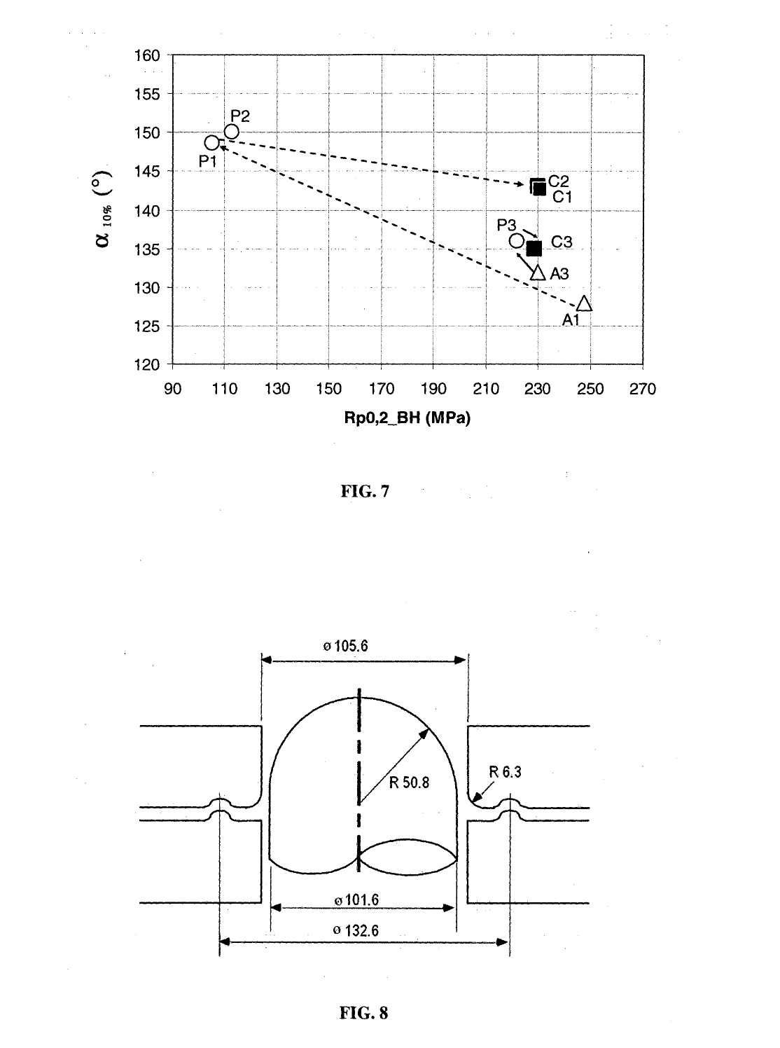

The results are shown in FIG. 7 with, on the Y-axis, the bending angle in degrees and, on the X-axis, Rp_{0,2}-BH in MPa as before.

Firstly, considering points C1, C2, C3, it is found that, for the same value of Rp_{0,2}-BH, hemming ability using the bending test for composite materials C1 and C2 according to the invention is clearly higher than that of composite material C3 outside the scope of the invention.

So although core A3 of composite C3 is more bendable than core A1 of composites C1 and C2, the fact that covers P1 and P2 are more bendable than cover P3 results in diminished hemming ability or bendability for composite C3.

Thus, contrary to what is learned from prior art and in particular application EP 1852250 A1 by “Aleris Aluminum Duffel BVBA”, it is much better to clad a core made with AA6016 alloy with a clad sheet with a low value for Rp_{0,2}-BH but excellent hemming ability or bendability rather than use an alloy of the AA6005A type for the clad sheet. In particular, the fact that the magnesium content of clad sheets of composites C1 and C2 according to the invention is less than 0.3% significantly improves hemming ability or bendability.

### Example 5

In this example, the two composite materials of Example 1, C1 and C2 according to the invention, were used again and compared to a monolithic sheet of composition A1 with the same thickness of 1 mm, also from Example 1.

Its aim is to show that the material according to the invention in addition to the fact that it has improved hemming ability after shaping in T4P temper while retaining significant hardening ability during paint baking, also has better formability for stamping in the same T4P temper.

This last characteristic was evaluated by determining the parameter known to experts in the field as the LDH (Limit Dome Height). This is widely used for evaluating the drawing ability of sheets of thickness 0.5 to 2 mm. It has been the subject of numerous publications, notably by R. Thompson, “The LDH test to evaluate sheet metal formability—Final Report of the LDH Committee of the North American Deep Drawing Research Group”, SAE conference, Detroit, 1993, SAE Paper n° 9308 15. This is a cupping test of a blank whose edge is clamped by a bead. The blank-holder pressure is controlled to prevent slipping into the bead. The blank, size 120×160 mm, is loaded in a fashion similar to plane deformation. The punch used is hemispherical. FIG. 8 specifies the dimensions of the tools used in this example to perform this LDH test.

Lubrication between the punch and the sheet is provided by graphite grease (Shell HDM2 grease). The speed of descent of the punch is 50 mm/min. The LDH value is the movement of the punch to break, or the maximum depth of drawing. The average of three tests is taken, giving a confidence range at 95% on the measurement of ±0.2 mm.

Table 3 below shows the values of the LDH parameter obtained on specimens of 120×160 mm cut from the above sheets and in which the dimension of 160 mm was positioned parallel to the rolling direction.

TABLE 3

| | LDH (mm) |
|---|---|
| A1 | 26.7 |
| C1 | 27.7 |
| C2 | 27.3 |

It is noted that both the composites C1 and C2, according to the invention, have a higher LDH value than the monolithic sheet of composition A1 of the same thickness 1 mm.

### Example 6

This example is intended to demonstrate the behavior of the material according to the invention as regards the appearance of roping during shaping.

To do this the roping test as described below was used:

A strip of approximately 270 mm (in the cross direction) by 50 mm (in the rolling direction) is cut from the test material. A tensile pre-strain of 15% across the direction of rolling, or along the length of the strip, is then applied. The strip is then subjected to the action of an abrasive paper of type P800 so as to reveal said roping defect. This is then assessed visually and transferred by rating onto a scale from 1 (high roping) to 5 (complete absence of roping).

The sheet composites used in this example were produced by hot co-rolling from a core sheet A4 and two clad sheets P4. Two composites C4 and C5 were made twice by hot co-rolling, hot rolling and then cold rolling, with a final total thickness of 1 mm and on each side two cladding sheets each representing 5% and 10% of the total final thickness of 1 mm respectively.

The composite material C4 according to the invention is composed of a core sheet of composition A4 and two cladding sheets of the same composition P4. The C4 material has on each face two clad sheets each of which accounts for 5% of the total final thickness.

The composite material C5 according to the invention is composed of a core sheet of composition A4 and two cladsheets of the same composition P4. The C5 material has on each face two clad sheets each of which accounts for 10% of the total final thickness.

The compositions of the constituent parts of these two composite materials, expressed in percentages by weight, are summarized in Table 4 below:

TABLE 4

| | Si | Fe | Cu | Mn | Mg | Cr |
|---|---|---|---|---|---|---|
| A4 | 1.12 | 0.24 | 0.17 | 0.16 | 0.66 | 0.03 |
| P4 | 0.55 | 0.25 | 0.18 | 0.09 | 0.26 | 0.02 |

other elements <0.05 each and 0.15 in total, the remainder being aluminum.

Meanwhile, another plate corresponding to the A4 composition of Table 4 was transformed to obtain a monolithic sheet of final thickness of 1 mm.

In each case presented above, two cold rolling processes were implemented, one without intermediate annealing (indicated subsequently by index a) and the other with intermediate annealing (index b) designed to improve the surface appearance after shaping and painting.

After cold rolling, the various composite materials were solution heat treated at 550° C., quenched and pre-aged by winding at about 50° C. with slow cooling in the coil down to room temperature.

After a two-week wait at room temperature, roping of the different materials, then in the T4P temper, was evaluated according to the procedure described in the procedure already described.

The results obtained are given in table 5 below.

TABLE 5

| | Cotation |
|---|---|
| A4-a | 1 |
| C4-a | 4 |
| C5-a | 5 |
| A4-b | 4 |
| C4-b | 5 |
| C5-b | 5 |

It appears that, in the case of a transformation without intermediate annealing (index a), the A4-a core has a significant roping defect, while the C4-a composite material, consisting of the same A4 core and two clad sheets each with a thickness of 5%, has a very good surface appearance becoming excellent in the case of a composite material comprising two C5-a cladding sheets with a thickness of 10% each.

In the case where core A4-b itself has undergone a transformation with intermediate annealing, and therefore has a very good surface appearance (rating 4), composites C4-b and C5-b obtained by cladding this core lead to similar or better roping results (rating 5).

The invention therefore makes it possible to eliminate intermediate annealing without compromising performance in terms of behavior with regard to the roping defect.

1. Composite aluminum alloy sheet material for motor vehicle body component, wherein a clad sheet, or clad, with a thickness of 5 to 10% of total thickness of the composite material is applied to at least one side of a core, wherein compositions of said clad and said core, as percentages by weight, are as follows:

| | Si | Fe | Cu | Mn | Mg | Cr | Zn | Ti |
|---|---|---|---|---|---|---|---|---|
| Core | 1.1-1.3 | <0.3 | <0.3 | 0.05-0.3 | 0.4-0.8 | <0.2 | <0.3 | <0.2 |
| Clad | 0.3-0.9 | <0.3 | <0.3 | 0.05-0.3 | 0.15-0.30 | <0.2 | <0.3 | <0.2 |

other elements <0.05 each and 0.15 in total, remainder being aluminum.

2. Composite sheet material according to claim 1, wherein the magnesium content of the core alloy is from 0.4 to 0.7.

3. Composite sheet material according to claim 1, wherein the manganese content of the core and/or clad alloy is from 0.05 to 0.2.

4. Composite sheet material according to claim 1, wherein the copper content of the core is not more than 0.2.

5. Composite sheet material according to claim 1, wherein the silicon content of the clad is from 0.45 to 0.65.

6. Composite sheet material according to claim 1, wherein the magnesium content of the clad is from 0.23 to 0.29.

7. Composite sheet material according to claim 1, wherein the manganese content of the clad is from 0.10 to 0.30.

8. Composite sheet material according to claim 1, wherein the clad has been applied to the core by co-rolling.

9. Composite sheet material according to claim 1, wherein a clad is applied to only one side of the core.

10. Composite sheet material according to claim 1, wherein a clad is applied to both sides of the core.

11. Composite sheet material according to claim 1, wherein said sheet material has a “three-point bending angle” (α_{10%}) measured according to standard NF EN ISO 7438, in the T4P temper, or solution hardened, tempered, pre-aged by winding, optionally from 50 to 85° C., and slowly cooled down to room temperature in the coil, of at least 140° after a tensile pre-strain of 10%.

12. Composite sheet material according to claim 11, wherein said “three-point bending angle” (α_{10%}), obtained just after a tensile pre-strain of 10%, of at least 140°, is substantially invariable, or optionally shows a change of less than 5°, with waiting time at room temperature after cooling the coil, for a waiting time of up to at least 6 months.

13. Composite sheet according to claim 1, wherein yield strength Rp_{0,2}, after solution heat treatment, quenching, pre-aging by winding, from 50 to 85° C., and cooling slowly in the coil down to room temperature, tensile pre-strain of 2%, and paint baking treatment for 20 min at 185° C., is at least 200 MPa and optionally at least 220 MPa.

14. Composite sheet according to claim 1, wherein said sheet has a “three-point bending angle” (α_{10%}), measured according to standard NFEN ISO 7438, in T4P temper, or solution heat treated, quenched, pre-aged by winding, from 50 to 85° C., and slowly cooled in coil down to room temperature, of at least 140° after tensile pre-strain of 10%, and further wherein said sheet has a yield strength Rp0,2, after solution heat treatment, quenching, pre-aging by winding, from 50 to 85° C., and slow cooling in the coil down to room temperature, tensile pre-strain of 2%, and paint baking treatment for 20 min. at 185° C., is at least 200 MPa and optionally at least 220 MPa.

15. Motor vehicle body sheet wherein said motor vehicle sheet is made from the composite sheet material according to claim 1.

16. Motor vehicle body sheet of claim 15, wherein said motor vehicle body sheet is a drawn sheet.

17. Motor vehicle body sheet according to claim 15, wherein said motor vehicle body sheet is a hemmed sheet.

18. Method of manufacturing a composite aluminum alloy sheet material according to claim 1, comprising applying a clad sheet by co-rolling onto at least one side of a core, wherein compositions of the core and the clad sheet are, as percentages by weight, as follows:

| | Si | Fe | Cu | Mn | Mg | Cr | Zn | Ti |
|---|---|---|---|---|---|---|---|---|
| Core | 1.1-1.3 | <0.3 | <0.3 | 0.05-0.3 | 0.4-0.8 | <0.2 | <0.3 | <0.2 |
| Clad | 0.3-0.9 | <0.3 | <0.3 | 0.05-0.3 | 0.15-0.30 | <0.2 | <0.3 | <0.2 |

other elements <0.05 each and 0.15 in total, remainder being aluminum.
